(19) United States
(12) Patent Application Publication
(10) Pub. No.: US 2009/0010784 A1
(43) Pub. Date: Jan. 8, 2009

(54) Powdered metals and structural metals having improved resistance to heat and corrosive fluids and b-stage powders for making such powdered metals

(75) Inventors: Edward E. Welker, Carmel, IN (US); Mitchell L. Spencer, Carmel, IN (US); Viswanathan Panchanathan, Anderson, IN (US)

Correspondence Address: John D. Ritchison;RITCHISON LAW OFFICES, PC, Siute A, 115 East Ninth Street, Anderson, IN, 46016-1509, US

(73) Assignee: MBS Engineering, LLC, Carmel, IN (US)

(21) Appl. No.: 12/152,383

(22) Filed: May 13, 2008

Related U.S. Application Data
(60) Provisional application No. 60/958,659, filed on Jul. 6, 2007.

(51) Int. Cl. F04B 17/03; B32B 5/16; B32B 15/098; B32B 27/04; B05D 5/00; B05D 7/00; C08L 61/10

(52) U.S. Cl. 417/423.7; 428/411.1; 428/524; 428/323; 428/457; 428/330; 427/393.5; 427/130; 524/594; 252/62.57

(57) ABSTRACT

Improved resin-bonded powdered metal components are protected against corrosion and reduction of crush strength during contact with corrosive fluids such as alcohols, ethanol-containing fuels, glycols and peroxide-containing fuels by a resin system coating that, when cured, provides a relatively high crosslink density and relatively few hydrolysable radicals. Magnetic properties of resin-bonded powdered metal magnets are protected from heat degradation by the cured resin coating. The coating can be a heat-cured resin system comprising a phenol novolac resin and a compatible hardener. In one embodiment magnetizable powdered materials have an uncured resin system coating to provide a B-stage material that can be cured after compression shaping.

### CROSS-REFERENCE TO RELATED APPLICATIONS

This application claims the benefit of Provisional Patent Application Ser. No. 60/958,659 filed Jul. 6, 2007 by Edward E. Welker and entitled “Powdered Metals and Structural Metals Having Improved Resistance to Corrosive Fluids and B-Stage Powders for Making Such Powdered Metals”.

### BACKGROUND OF THE INVENTION

1. Field of the Invention

This invention relates generally to components, including resin-bonded powdered metal components that are protected from the degrading effects of heat and long-term contact with corrosive fluids such as alcohols, ethanol-containing fuels, glycols, biodiesel fuels, peroxide and peroxide-based fuels. More specifically, the invention relates to devices that incorporate such components and are adapted for use at elevated temperatures and for long term contact with such corrosive fluids or for submerged operation in such fluids. The invention relates also to metal powders coated with a curable resin system, the coated powders being suitable for use in the manufacture of such components and devices.

2. Background of the Invention

Automotive electric fuel pump motors have for many years been designed to operate inside vehicle fuel tanks, in contact with fuel. The component parts of in-tank electric fuel pumps normally include powdered metal magnets. Such electric fuel pumps and their component parts are bathed constantly in fuel and must resist corrosion, softening and other damage resulting from such an operating environment. Fuel pump motors have operated successfully for long periods of time submerged in fuel containing up to 10% ethanol. However, in recent years a growing number of vehicles have been adapted to operate using E-85 fuel, which is 85% ethanol; and the higher concentrations of alcohol have been found to cause softening of the resin binders in powdered metal structures and corrosion of active metals such as Fe, Al and rare earth compounds containing active metals, such as Nd—Fe—B compounds. Softened and corroded components can shed particles into fuel systems, can lose magnetic properties or can change shape causing, for example, a powdered metal magnetic rotor to bind with its corresponding stator. In-tank fuel pumps that incorporate powdered metal components, such as magnets, and the use of such pumps in contact with fuels containing high levels of ethanol are exemplary of devices and environments that give rise to concern. It is a further concern that ethanol, ethanol-containing fuels and other corrosive fluids come into contact with both powdered metal components and structural metals in other automotive and industrial applications. Such fluids include alcohols, alcohol-containing fuels, biodiesel fuels, glycols, peroxide and peroxide-containing fuels.

It also is a concern, especially in the automotive fuel supply business, that tanks, delivery pipes and pump parts made of active structural metals, such as aluminum and iron are subjected to high concentrations of such corrosive fluids for long periods of time. Unprotected aluminum, iron and other metals can be corroded by high concentrations of such fluids. Stainless steel is not as easily corroded and, in theory, could be substituted for aluminum in applications for the storage and delivery of such corrosive fluids; however, its weight differential over aluminum makes it impractical to use in many applications, as does its added cost over that of aluminum and iron.

The effects on active metal structural components and on powdered metal components caused by extended contact with such corrosive fluids are seen as serious problems in automotive and industrial applications. Especially in the automobile industry, the increasing popularity of fuels containing high alcohol concentrations is associated with an increasing need to protect both powdered metal components and structural metal components from the adverse effects of constant exposure to fuels containing high concentrations of ethanol.

It has long been a problem for those involved in making and using powdered metal magnets that exposure of the magnets to elevated temperatures results in loss of magnetic properties. There is a need for a powdered metal magnet that retains more of its magnetic properties when exposed to high temperatures.

### BRIEF SUMMARY OF THE INVENTION

It is an object of the invention to overcome these and other problems of the prior art.

It is also an object of the invention to protect both powdered and structural metal components from the corrosive effects of long-term exposure to such corrosive fluids generally and especially to fuels containing high concentrations of ethanol.

It is a further object of the invention to provide resin-coated powdered metals that can be formed and cured into components that resist the softening and corrosive effects of long-term contact with such corrosive fluids and especially with fuels containing high concentrations of ethanol.

It is still another object of this invention to provide devices such as electric motors having powdered metal or structural metal components that resist corrosion and softening when submerged in corrosive fluids such as alcohol-containing fuels for long periods of time.

It also is an object of this invention to provide devices such as electric fuel pumps with powdered metal components that resist the corrosive and softening effects of such corrosive fluids when operating for long periods of time while in contact with or submerged in such fluids.

An additional object of this invention is to provide tanks, pumps and conduits useful in the production, storage and delivery of such corrosive fluids.

Still another object of this invention is to provide powdered metal magnets that retain more of their magnetic properties following exposure to high temperatures.

These and other objects are accomplished by the present invention which, in one aspect, is a B-stage material comprising a powdered material that, optionally, has magnetic properties and is at least partially coated with a curable resin system, the coated, powdered material being suitable for pressing into a useful shape prior to curing of the resin. The resin system comprises a phenol novolac resin having a high crosslink density and a low level of hydrolysable sites when cured. In a preferred embodiment the resin system includes a diamine crosslinker or hardener and curing is heat activated.

In another aspect, the invention is a shaped component comprising a structural metal such as aluminum or cast iron, the structural metal being coated, at least in areas expected to contact corrosive fluids, with a protective coating comprising cured novolac resin system having a high crosslink density and a relatively low level of hydrolysable radicals. Such shaped structural material may be adapted for use in producing, storing, transporting, delivering or using corrosive fluids such as alcohols, biodiesel fuels, glycols, peroxide, peroxide-containing fuels and automotive fuels having relatively high ethanol contents.

In yet another aspect the invention is a shaped powdered metal component, such as a rotor magnet for use in an electric motor, the component comprising powdered metal bound in a cured resin system, the system comprising a phenol novolac resin having a high crosslink density and a low concentration of hydrolysable moieties.

In still another aspect, the invention includes devices incorporating such shaped powdered metal components or such structural material. Devices incorporating such components are exemplified by electric fuel pumps and tanks, conduits, pipes and controls for the manufacture, storage, transportation, use and delivery of such corrosive fluids.

In yet another aspect the invention is an improved powdered metal magnet that retains more of its magnetic properties upon exposure to heat, and includes devices incorporating such an improved magnet.

The invention is based on the discovery that components comprising powdered metal in a resin binder will demonstrate improved resistance to ethanol and improved retention of magnetic properties when the cured resin binder has a high crosslink density and a reduced number of hydrolysable moieties, such chlorine.

Referring more specifically to powdered metal devices and to B-stage powders, any useful particulate material may be used. Typically, however, the material is a powdered magnetic material. B-staged magnetic materials can be formed into powdered metal components for use in electrical devices, as is exemplified by the use of powdered metal magnetic rotors in electric motors.

Generally speaking, the powdered magnetic material will be a compound that comprises rare earths, transition metals and boron. Magnetic materials include ferrites, samarium-cobalt, aluminum-nickel-cobalt, and neodymium-iron-boron type materials. In recent years neodymium-iron-boron has been used for many bonded magnet applications. Preferably the compounds will be made from Nd, Pr, Fe, Co and B. Industrial use of powders as a component in the manufacture of powdered metal magnets has centered around Nd₂Fe₁₄B and its derivatives, such as Dy₂Fe₁₄B; DyₓNd₂₋ₓFe₁₄B; Pr₂Fe₁₄B, and PrₓNd₍₂₋ₓ₎Fe₁₄B. As is well known in the art, cobalt may be substituted for all or part of the iron in the neodymium-iron-boron phase of the magnet. Other metals such as niobium, titanium, zirconium, vanadium, tungsten etc can be added to neodymium-iron-boron alloys to obtain desired magnetic properties. Other rare earth metals, such as, but not limited to, cerium, dysprosium, erbium, praseodymium and yttrium may be substituted for all or part of the neodymium. Part or all of the boron may be replaced by carbon, silicon or phosphorous. Other metals or nonmetals may be substituted for small portions of either the iron or the neodymium, and the relative proportions of the neodymium, iron, and boron may be varied slightly. Usually Nd—Fe—B material is obtained by the rapid solidification process. Other methods, such as using hydrogen, also can be used to make these magnetic materials.

The particle size of useful powdered materials varies widely depending on particular applications. Typically, powdered metals useful in the present invention have an average particle size of about 150 microns, although particle sizes ranging from about 20 to about 400 microns may be useful. Magnetic metal particles useful in the present invention are commercially available, for example, from Neo Materials Technologies (Magnaquench), Toronto, Ontario, Canada.

In accordance with the present invention, useful B-stage powders are at least partially coated with [include coatings of] an uncured resin system comprising a phenol novolac resin and a diamine crosslinker or hardener. The resin system of the present invention provides a high crosslink density, especially when compared with the bisphenol A-epichlorohydrin or bisphenol F-epichlorohydrin epoxy resin systems that have been used in the past to form B-stage metal powders. It also is characteristic of phenol novolac resin systems that a relatively low ratio of hydrolysable moieties, such as chlorides, is present in the cured resin. Other hardener systems can be used with the phenol novolac resin depending on the application and the curing method. Illustrative examples of other useful hardeners for phenol novolac resins are amines, polyamides, anhydrides, phenolic resins, polymercaptans, isocyanates and dicyandiamides

B-stage powders normally are used to form powdered metal shapes by a well-known compression process in which high pressure is applied to a pre-measured charge of the powder held in a die cavity. The pressure applied typically is about 60 tons/square inch. The resulting shape is then cured by heating at atmosphere to a temperature sufficient to initiate crosslinking. Typically the curing temperature is about 170 degrees C. and is maintained for less than an hour.

The ratio of resin to crosslinker may be determined by stoichiometric calculations that normally result in a resin:crosslinker ratio of about 4:1. Suitable phenol novolac resins and hardeners, such as diamine crosslinkers, are commercially available from suppliers such as Dow Chemical Co. (Midland, Mich.)

The method of making the B-stage material is adapted to provide a flowable coated powder of substantially uniform particle size that can be compressed into a predetermined shape and then heat cured. There are a variety of suitable manufacturing methods available to accomplish that end. For example, liquid novolac resin, diamine crosslinker and, optionally, a diluent such as acetone, are mixed with the powdered material, by stirring. Alternatively, the powder may be coated with the liquid combination of resin and crosslinker using a fluidized bed and spray coating. Also a mechanical blender may be used to coat the powder with a resin system. After coating, the powder is dried and the diluent, if any, is removed to result in a flowable material of substantially uniform particle size.

When the invention is a structural component, the resin system may be applied by spray coating or by painting. The resin system coated on structural components may be substantially the same as the resin coating used to coat particles. In such cases the resin coating is and the structural component that supports it must be heated to cure the resin system. However, when the structural component is large, heat curing may be inconvenient. In such cases crosslinking may be catalyzed chemically or actinically.

Structural components that may be coated with a resin material include, for example, aluminum tanks, pipes, pump components and controls used in the manufacture, storage, transportation and delivery of alcohols and fuels containing a high ratio of alcohols.

The present invention was compared with the prior art in the following examples, which are intended to be representative and not exhaustive.

### DETAILED DESCRIPTION OF THE INVENTION

### Example 1

A group of test cylinders or pills representing the prior art was made from magnetized powdered Nd₂Fe₁₄B having an average particle size of 150 microns coated with a heat-curable resin system comprising diglycidal ether—bisphenol A-epichlorohydrin (epoxy) resin and a dicyanamide hardener. The resin system comprised about 2.0 Wt. % of the resin-powder mixture. The resin-coated powder was formed into 10 mm diameter cylindrical pills by compression molding followed by heat curing at atmospheric pressure. The pills were each marked to indicate they belong to “Group A.”

A second set of pills was made as described above in connection with “Group A” and impregnated with a methylmethacrylate resin before each pill was marked to indicate it belonged to “Group B.”

A third set of pills was made as described in connection with the pills belonging to Group B with the additional step of electrocoating an epoxy film, or e-coat, prior to marking each e-coated pill as belonging to “Group C.”

Three pills from each of Groups A, B and C were subjected to a strength test to determine the load required to crush the pill. The pills from Group A crumbled at loads of 15,000 N, while the pills from Groups B and C broke apart at a load of 20,000 N. The remaining pills then were submerged in E-85 fuel, an automotive fuel comprising 85% ethanol, for 1,000 hours. Three pills from each group were withdrawn from the fuel bath and subjected to an identical strength tests after 500 hours and after 1,000 hours. The pills from Group A failed at about 5,000 N after 500 hours and also after 1,000 hours, showing a 67% loss in strength after 500 hours. The Group B pills crumbled at about 15,000 N at 500 hours (a 25% loss in strength) and at about 10,000 N after about 1,000 hours (a 50% loss in strength) while pills from Group C failed at about 12,500 N after 500 hours (a 38% loss in strength) and at approximately 5,000 N after 1,000 hours day (a 75% loss in strength).

The crush test results are summarized in Table 1. The crush test results confirm that powdered metal components comprising diglycidal ether—bisphenol-A epichlorohydrin resin binder lose a significant percentage of their original crush strength after a relative short time submerged in a high-alcohol automotive fuel. The crush test results further indicate that pills with a second resin fails to protect the components from the weakening effects of contact with alcohols. The crush tests for Group C pills also confirm that the application of an epoxy e-coat does not increase the resistance of the component to the weakening effects of high-alcohol fuels.

TABLE 1

| Hours | | Group A | | Group B | | Group C |
|---|---|---|---|---|---|---|
| Submerged | Group A Crush | Loss in | Group B Crush | Loss in | Group C Crush | Loss in |
| in E-85 Fuel | Strength | Strength | Strength | Strength | Strength | Strength |
| 0 | 15,000 N | | 20,000 N | | 20,000 N | |
| 500 | 5,000 N | 67% | 15,000 N | 25% | 12,500 N | 38% |
| 1,000 | 5,000 N | 67% | 10,000 N | 50% | 5,000 N | 75% |

### Example 2

Two sets of resin test strips measuring 35 mm by 13 mm by 3 mm were made by mixing liquid epoxy resins with liquid hardeners and pouring the uncured resin system into molds prior to heat curing. One set of test strips was made by mixing bisphenol-A type epoxy resin with a dicyanamide curing agent at a 4/1 wt./wt. ratio. Molds containing the bisphenol-A type resin were heat cured at 170 degrees C. for 50 minutes and, after cooling to room temperature were marked as belonging to Group D. A second set of test strips was made by mixing bisphenol-F type epoxy resin with a dicyanamide curing agent at the same wt./wt. ratio followed by heat curing under the same conditions. After cooling to room temperature, the second set of test strips were each marked as belonging to Group E.

A third set of test strips was made by mixing phenol novolac resin with a diamine crosslinker in a 4:1 resin-crosslinker ratio. After heat curing in molds and returning to room temperature each member of the third set of test strips was marked as belonging to Group F.

Three test strips from each of Groups D, E and F were testing for crush strength using the device described in Example 1 to establish a benchmark for initial crush strength for each group of pills. The remaining test strips were submerged in E-85 fuel. Three members of each group were removed from the E-85 fuel and subjected to identical crush strength testing after 400, 600, 1,000 and 1,500 hours.

Test strips in Group D retained 90% of their crush strength after 400 hours and over 80% after 600 hours but retained only about 50% of their crush strength after 1,000 and 1,500 hours. Test strips in Group E retained only 65% of their crush strength after 400 hours and 50% thereafter. By comparison, test strips formed of a phenol novolac resin and diamine crosslinker as used in the present invention increased crush strength by about 5% after 400 hours with no deterioration from the 105% strength throughout the balance of the test period. The results obtained in Example 2, summarized in Table 3, below, confirm the resistance of diamine-cured phenol novolac resins to alcohols such as the ethanol contained at high concentrations in E-85 automotive fuel. One notes there is no Table 2.

### Example 3

A Group of test pills was made by mixing together a phenol novolac resin and a diamine crosslinker in a 4:1 weight ratio and diluting with acetone. The magnetic powder described in Example 1 was slowly poured into the liquid resin system with stirring until a resin concentration of about 2.3 wt. percent was achieved, resulting in a flowable B-stage material. After removal of excess acetone and physical manipulation to break up any agglomeration, predetermined amounts of the resin-coated powder was poured into the cavity of a cold compression mold and subjected to pressure of about 60 tons/square inch to form pills that were subsequently heat cured as described in connection with Group A pills in Example 1. The pills of Example 3 each are marked as belonging to Group G.

Three pills of Group G are tested to obtain a benchmark reading of initial crush strength. The remaining pills of Group G are submerged in E-85. Three pills are removed at the, 400^{th}, 600^{th} and 1,000^{th} and 1,500^{th} hour of the test period and subjected to crush testing. Results of crush testing throughout the 1,500-hour test period, as summarized in Table 3, show an increase in crush strength to 105% after 400 hours and no reduction in crush strength thereafter. The protection of powdered metal components from the weakening effects of long-term contact with liquids containing high concentrations of alcohols, such as the ethanol contained in E-85 fuel is confirmed by the test results of Example 3.

TABLE 3

| | | Group E | Group F | Group G |
|---|---|---|---|---|
| Hours | Group D | Retained | Retained | Retained |
| Submerged in | Retained Crush | Crush | Crush | Crush |
| E-85 Fuel | Strength | Strength | Strength | Strength |
| 400 | 90% | 65% | 105% | 105% |
| 600 | 80% | 50% | 105% | 105% |
| 1,000 | 50% | 50% | 105% | 105% |
| 1,500 | 50% | 50% | 105% | 105% |

### Example 4

Samples as prepared in group A and group G are tested for magnetic properties at room temperature. The results are given in table 4.

TABLE 4

| | Group A | Group G |
|---|---|---|
| Remanence, Br, kG | 6.75 | 6.83 |
| Intrinsic | 9.50 | 9.43 |
| Coercivity, Hci, | | |
| kOe | | |
| Energy Product, | 9.47 | 9.72 |
| BHmax, MGOe | | |

The data in Table 4 indicate that the magnetic properties of powdered metal magnets made using epoxy resin and the magnetic properties of powdered metal magnets comprising novolac resin, are substantially equivalent.

### Example 5

Samples as prepared in group A and group G were subjected to aging test at 125 C. In this test magnets are aged at 125 C in an oven for 500 and 1000 hrs. The magnets were taken out of the oven at 500 hrs, cooled to room temperature and magnetic properties were tested. The loss in magnetic properties is known as the aging loss and is expressed as % of the original property. Similarly the aging loss after 1000 hrs was calculated. The test results are given in table 5.

TABLE 5

Aging loss %

| | Group A | Group G |
|---|---|---|
| After 500 Hours | 4.7 | 3.0 |
| After 1,000 Hours | 5.0 | 2.9 |

The data in Table 5 confirm that the aging losses at elevated temperature are at least 40% lower with magnets comprising novolac resin compared with those comprising regular epoxy resins.

### Example 6

The crush strength of samples from groups A and G was determined as in Example 1. Samples from groups A and G were immersed in regular unleaded gasoline for up to 1000 hrs. Samples withdrawn after 500 hours and tested for crush strength by the same procedure showed no loss in crush strength. Magnets withdrawn and tested after 1000 hrs immersion also showed no loss in crush strength. This example confirms that neither magnets comprising regular epoxy nor magnets comprising a novolac resin lose crush strength by soaking in regular unleaded gasoline. This example confirms that magnets comprising regular epoxy and magnets comprising novolac resins have no loss in crush strength by soaking in regular unleaded gasoline.

This specification describes a method of using novolac resin and making components that can be used effectively with newly developed bio-fuels. The presently-known epoxy based components can only be used with the regular unleaded gasoline without loss in strength; however components made in accordance with the present invention can be used in devices that will be in contact not only with regular unleaded gasoline, for example, but also with gasoline containing 85% ethanol. Thus a powdered metal magnet of the present invention can be used in electric fuel pumps, electric motors, and the like submerged in corrosive fluids over long periods of time without deterioration in properties and strength. The above examples further indicate that whether or not in contact with such corrosive fluids the high crosslink density and low hydrolysable content of the cured resin system protects powdered metal magnets from the reduction of magnetic properties by exposure to high temperatures.

What is claimed is:

1. A resin-bonded powdered-material component of predetermined shape having improved crush strength upon contact with corrosive liquids, the component comprising:
a. powdered material; and
b. a cured resin system bonding the powdered material, the resin system having high crosslink density and low hydrolysable content.

2. The component of claim 1 wherein the cured resin system comprises a novolac resin.

3. The component of claim 2 wherein the cured resin system is from about 0.5 wt. % to about 5.0 wt. % of the component.

4. The component of claim 2 wherein the powdered material has an average particle size of from about 20 microns to about 400 microns.

5. The component of claim 1 wherein the powdered material comprises magnetic material and wherein the component demonstrates magnetic properties that resist degradation upon exposure to elevated temperatures.

6. The component of claim 5 wherein the magnetic material comprises rare earths, transition metals, boron and mixtures thereof.

7. The component of claim 6 wherein the magnetic material comprises elements selected from the group consisting of Nd, Pr, Fe, B and Co.

8. The component of claim 1 adapted for use in contact with a fluid containing high concentrations of corrosive materials.

9. A flowable B-stage material curable to a component of predetermined shape having improved stability upon contact with corrosive liquids, the flowable B-stage material comprising:
a. a particulate material; and
b. a curable resin system at least partially coating the particulate material, the resin system being curable to a resin having a high crosslink density and a low concentration of hydrolysable moieties.

10. The B-stage material of claim 9 wherein the particulate material comprises magnetic material and wherein the B-stage material is curable to a component of predetermined shape with magnetic properties that have improved resistance to heat exposure.

11. The B-stage material of claim 10 wherein the particulate material comprises rare earths, transition metals, boron and mixtures thereof.

12. The B-stage material of claim 11 wherein the magnetic material comprises elements selected from the group consisting of Nd, Pr, Fe, B and Co.

13. The B-stage material of claim 9 wherein the cured resin system is from about 0.5 wt. % to about 5.0 wt. % of the component.

14. The B-stage material of claim 9 wherein the particulate material has an average particle size of from about 20 microns to about 400 microns.

15. The B-stage material of claim 9 comprising about 97.7% by weight of an Nd—Fe—B particulate material consisting essentially of Nd₂Fe₁₄B having an average particle size of about 150 microns coated with a heat curable resin system comprising about four parts phenyl novolac resin and about one part diamine crosslinker, the heat curable resin system comprising about 2.3% by wt. of the material.

16. A electric fuel pump adapted for operation submerged in a corrosive fuel containing a high concentration of ethanol, the electric fuel pump comprising a shaped, magnetic powdered metal component comprising about 97.7% by weight of an Nd—Fe—B particulate material consisting essentially of Nd₂Fe₁₄B having an average particle size of about 150 microns bound in about 2.3% by weight of a heat cured resin binder system comprising about four parts phenyl novolac resin crosslinked with about one part diamine hardener.

17. A method for protecting a material from a corrosive fluid comprising:
a. coating at least a portion of the material with an effective amount of a curable resin system that when cured has a relatively high crosslink density and a relatively low hydrolysable content; and
b. curing the resin system.

18. The method of claim 17 wherein the curable resin is a phenol Novolac resin.

19. The method of claim 17 wherein the material is a particulate having magnetic properties that are protected by the method from degradation by exposure to heat.

20. The method of claim 17 wherein the material is a structural component that is coated by spraying, immersion or painting.
